(19) United States
(12) Patent Application Publication
(10) Pub. No.: US 2009/0038490 A1
(43) Pub. Date: Feb. 12, 2009

(54) METHOD FOR PRINTING SECURITY DOCUMENTS, AND SECURITY DOCUMENT

(75) Inventor: Matthias Gygi, Montreux (CH)

Correspondence Address: CROMPTON, SEAGER & TUFTE, LLC, 1221 NICOLLET AVENUE, SUITE 800, MINNEAPOLIS, MN, 55403-2420, US

(73) Assignee: KBA-GIORI S.A., Lausanne (CH)

(21) Appl. No.: 11/573,994

(22) PCT Filed: Aug. 19, 2005
(86) PCT No.: PCT/IB05/02453

§ 371 Date: Feb. 20, 2007

(30) Foreign Application Priority Data
Aug. 24, 2004 (EP) 04020017.2

(51) Int. Cl. B41M 1/10

(52) U.S. Cl. 101/170

(57) ABSTRACT

The invention concerns a method for printing security documents (1) comprising in particular a lacquering step which consists in depositing a protective layer on the surface of the security documents, as well as a typographic printing step which consists in printing at least one typographic element (4) on said security documents following the lacquering step. Therefor, prior to the typographic printing step, at least one roughened surface (3) is formed on the security documents, for receiving a typographic element. The roughness of the surface (4) provides better adherence of the typographic ink on the documents already provided with a protective coating produced, for example, with a UV-curable lacquer.

The present invention relates to a method for printing security documents, such as banknotes and security papers, comprising especially a lacquering step during which a protective layer is deposited on the surface of said security documents and a typographical printing step during which at least one typographical element is printed on said security documents. The invention also relates to such a security document.

With the aim of protecting banknotes and security papers from premature wear, due to the handling that they undergo, and thus to prolong their lifetime, a protective layer is applied to the sheets or the reel on which they are printed during one of the final steps of the manufacturing process.

In document FR-A-523278, such a protective layer has already been provided for printed documents and the like. Patents EP-A-0 256 170 and EP-A-0 860 296, which are incorporated in the present patent application for reference, disclose the production of banknotes and security papers that are provided with a protective layer. In U.S. Pat. No. 6,227,572, raised elements are created by deforming the paper, so as to form, for example, an indication of the value of the banknote in Braille for those who are partially sighted. At least the region comprising these raised elements is reinforced by a layer of lacquer.

During the manufacture of a banknote or a security paper, after the paper has been printed on both sides and the quality of the printing checked, the banknotes meeting the quality criteria are numbered, a protective lacquer is applied, as described for example in the aforementioned documents, and then the sheets undergo the final finishing steps, such as cutting into individual banknotes, formation of packets, counting, etc. During application of the protective lacquer on both sides of each sheet, certain sheets may be partly or completely blemished. In this case, the already numbered banknotes are unusable and it is necessary either to reuse the missing numbers on other sheets or to print a special series, and these new sheets must be inserted into the stack at the correct point so as to obtain bundles with numbering in sequence.

To avoid this painstaking and expensive work, it has been proposed to print the numbers, or any other typographical element, on the banknotes and security papers after the protective layer has been applied and the quality checked so as to discard the blemished sheets or banknotes. Thus, the printing of special numbers or the recovery of unused numbers is limited to any numbers that are poorly printed.

It has been found that the adhesion and the resistance of the typographical inks used for printing the numbers on paper with the protective layer, especially when this is a layer of a UV-curable lacquer, is slight. In addition, when the printing of the face of the banknote on which the number is printed is carried out by intaglio printing, the paper is subjected to a very high pressure and it becomes smooth. This does not promote adhesion of the ink used for the numbering.

The present invention proposes a method for printing at least one typographical element on lacquered security documents such as banknotes and security papers, which allows these drawbacks to be alleviated.

The method according to the invention is characterized in that said typographical printing step is carried out after said lacquering step and in that, before said typographical printing step, at least one roughened field intended to receive said at least one typographical element is formed on said security documents.

The roughness of the field created and intended to receive the typographical element, such as an alpha-numeric serial number, a signature, a date of issue or the like, allows the typographical ink to adhere well. The typographical element may also be any other authentication element unique to the security document, such as a barcode or other design that can be read by a special machine, and including elements that differ from one security document to another.

According to one embodiment, the roughened field consists of a grid of dots or lines.

According to one embodiment, the roughened field is formed, before or after said lacquering step, by locally increasing the asperities of the surface of said security documents.

According to another preferred embodiment, said roughened field is formed by an intaglio printing process, the intaglio printing plate whose region intended to form the roughened field may or may not be inked.

According to another embodiment, the roughened field may be produced by stamping, before or after the lacquering step, or by any other means for increasing the roughness of the surface of the substrate or of the protective layer, for example a localized chemical treatment or a treatment using a beam, such as a laser beam, striking the surface of the document.

According to one embodiment, the size of the roughened field is greater than the size of the typographical element that has to be printed thereon.

According to one embodiment, the protective layer is produced by means of a UV-curable lacquer.

The invention also relates to a security document as claimed in one of claims 11 to 14.

The invention will be described in greater detail with the aid of the single figure showing schematically a banknote seen in plan view.

The banknote 1 is printed on both sides using conventional processes employed in the field of printing banknotes and security papers, that is to say offset printing, intaglio printing, Orloff printing, screen printing, etc. During printing of the pattern 2 on the front side of the banknote 1, a roughened field 3 is created, advantageously in an intaglio printing process. The intaglio printing plate includes a region identical in dimensions to the field 3, provided with several notches differing in shape and depth which, as the paper passes between the intaglio plate and the plate of the printing cylinder, will form, on the paper, a roughened field comprising, in relief, a grid of lines and dots corresponding to the notches in the intaglio plate. These reliefs may be practically invisible to the naked eye, if said region of the intaglio plate is not inked, but they are detectable to the touch. We have shown these reliefs by dots and fine lines in the figure. After having passed through the various quality checks, those sheets that are not rejected are covered with a protective layer, such as for example a UV-curable lacquer (alternatively, it could be any other type of lacquer, such a heat-curable lacquer). After the lacquer has cured and a final check has been made, so as to discard the sheets blemished during application of the protective layer, the sheets pass into a conventional numbering machine, which applies an individual serial number 4 (and also other typographical elements (not shown), such as a signature or a date of issue) to each unblemished banknote 1. The roughened field 3 allows the typographical ink to adhere well despite the presence of the protective layer.

Thereafter, the sheets are conveyed to the usual finishing installation, for checking the numbering printing, for cutting, for bundle formation, etc.

The field 3 extends around the number or typographical element so as to cover a larger area (a few tens of a millimeter are sufficient) and to take into account any inaccuracies when printing the numbers.

As mentioned above, several typographical elements may be printed on a security document such as a banknote, for example the serial number, a signature, the date of issue or any other element that it is desirable to print by typography.

The use of the intaglio printing plate for producing the roughened field 3 is a preferred implementation. However, the roughened fields may alternatively be formed by stamping, by localizing chemical treatment or by a beam that strikes the surface of the security document, for example a laser beam. This operation may also be carried out independently, before or after deposition of the productive layer. What is important is to create, before the typographical element is printed, a roughened field that allows good adhesion of the typographical ink to the protective layer. It is particularly advantageous to produce the field 3 during intaglio printing in that this does not require an additional step. As already mentioned, it simply suffices to provide an appropriate field on the intaglio printing plate.

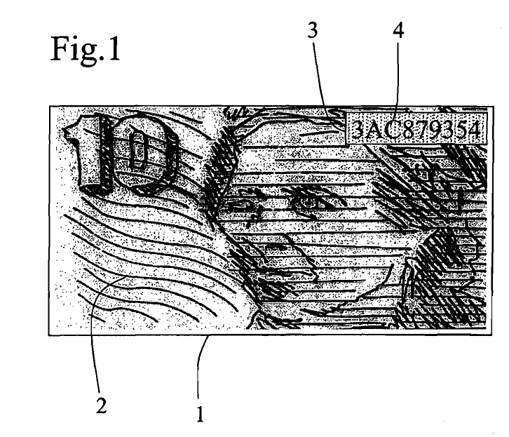

The invention also relates to a security document, like that described with the aid of FIG. 1, comprising a substrate, the faces of which bear print, a protective layer affixed to said substrate, and a roughened field in which a typographical element affixed to said protective layer is printed.

The roughened field is formed, before lacquering, from asperities made on the surface of said substrate in such a way that they are manifested on the surface of said protective layer after lacquering. Alternatively, the roughened field may be formed, after lacquering, from asperities made directly on the surface of said protective layer. As already mentioned, the asperities preferably consist of a grid of dots and/or lines.

1. A method for printing security documents, such as banknotes and security papers, comprising especially a lacquering step during which a protective layer is deposited on the surface of the security documents and a typographical printing step during which at least one typographical element is printed on the security documents, wherein the typographical printing step is carried out after the lacquering step and in that, before the typographical printing step, at least one roughened field intended to receive the at least one typographical element is formed on the security documents.

2. The method as claimed in claim 1, wherein the typographical element is an alphanumeric serial number, a signature or a date of issue.

3. The method as claimed in claim 1, wherein the roughened field has asperities consisting of a grid of dots and/or lines.

4. The method as claimed in claim 1, wherein the roughened field is formed, before or after said lacquering step, by locally increasing the asperities of the surface of the security documents.

5. The method as claimed in claim 4, wherein the roughened field is formed, before or after deposition of the protective layer, by stamping.

6. The method as claimed in claim 4, wherein the roughened field is formed, before or after deposition of the protective layer, by a chemical treatment.

7. The method as claimed in claim 4, wherein the roughened field is formed, before or after deposition of the protective layer, by a treatment using a beam that strikes the surface of the document.

8. The method as claimed in claim 4, wherein the roughened field is formed before the lacquering step by an intaglio printing process using an intaglio printing plate whose region intended to form the roughened field may or may not be inked.

9. The method as claimed in claim 1, wherein the size of the roughened field is greater than the size of the typographical element that has to be printed thereon.

10. The method as claimed in claim 1, wherein the protective layer is produced by means of a UV-curable lacquer.

11. A security document, especially a banknote or a security paper, comprising a substrate, the faces of which bear print, a protective layer affixed to the substrate, and a roughened field on which a typographical element affixed to the protective layer is printed.

12. The security document as claimed in claim 11, wherein the roughened field is formed from asperities made on the surface of the substrate and being manifested on the surface of the protective layer.

13. The security document as claimed in claim 11, wherein the roughened field is formed from asperities made directly on the surface of the protective layer.

14. The security document as claimed in claim 11, wherein the roughened field has asperities consisting of a grid of dots and/or lines.
